(19) United States
(12) Patent Application Publication
(10) Pub. No.: US 2003/0178749 A1
(43) Pub. Date: Sep. 25, 2003

(54) Closing unit for an injection molding machine, and method of making a plurality of injection-molded articles

(75) Inventor: Timo Gunzel, Dachau (DE)

Correspondence Address: HENRY M FEIEREISEN, LLC, 350 FIFTH AVENUE, SUITE 4714, NEW YORK, NY, 10118, US

(73) Assignee: KRAUSS-MAFFEI KUNSTSTOFFTECHNIK GMBH, Munchen (DE)

(21) Appl. No.: 10/385,945

(22) Filed: Mar. 11, 2003

(30) Foreign Application Priority Data
Mar. 19, 2002 (DE) 102 120 44.7-16

(51) Int. Cl. B29C 45/14; B29C 45/10

(52) U.S. Cl. 264/328.12; 425/112; 425/170; 425/562; 425/572

(57) ABSTRACT

A closing unit for an injection molding machine for making several injection molded articles in one working cycle includes a fixed mold portion and a movable mold portion which is movable by a drive mechanism in a direction of the fixed mold portion. The fixed and movable mold portions bound a mold cavity, when the movable mold portion is forced by the drive mechanism against the fixed mold portion and held in place in a clamped position by a clamping force applied by the drive mechanism. A separator assembly subdivides the mold cavity into at least two distinct cavity zones, with each cavity zone including sub-cavities. Injection molding material is supplied through a single sprue via separate feed channels to the cavity zones, wherein a valve assembly is disposed in the sprue to control the supply of injection molding material to the cavity zones via the feed channels in time-staggered manner, when the mold portions assume their clamped position.

### CROSS-REFERENCES TO RELATED APPLICATIONS

This application claims the priority of German Patent Application, Serial No. 102 120 44.7-16, filed Mar. 19, 2002, pursuant to 35 U.S.C. 119(a)-(d), the disclosure of which is incorporated herein by reference.

### BACKGROUND OF THE INVENTION

The present invention relates to a closing unit for an injection molding machine, and to a method of making a plurality of injection-molded articles.

Injection molding machines for making injection molded articles of large size or for simultaneous production of a plurality of several smaller injection molding articles require powerful drive mechanisms for applying a sufficient clamping force to maintain the mold portions during injection in clamped position, i.e. to counteract forces that tend to move the molding portions apart as a consequence of the product of internal pressure in the mold and cross sectional area of the mold cavity. For example, the manufacture of simultaneously eight conventional drinking cups requires the use of a 300-400 to injection molding machine, while the manufacture of table tops at a size of 80×120 cm through injection molding is possible only when machine configurations of 1600-2000 to are used. As a result, the need for space and energy is substantial so that injection molding machines become cost-intensive.

German patent publication DE 36 07 410 A1 discloses a method and apparatus for injection molding plastic articles, whereby the injection is subdivided into at least two injection operations which are implemented in succession. Each individual injection operation takes place in a separate injection mold portion, with the injection mold portions together defining the injection mold. During successive injection into the mold portions, the materials are united at a common transition in such a manner as to form a single-piece molded article.

It would be desirable and advantageous to provide an improved closing unit for an injection molding machine and an improved method of making a plurality of injection-molded articles, to obviate prior art shortcomings and to reduce the overall machine dimension as well as forces that tend to move mold portions apart, while still being reliable in operation.

### SUMMARY OF THE INVENTION

According to one aspect of the present invention, a closing unit for an injection molding machine for making several injection molded articles in one working cycle, includes a fixed first mold portion, a movable second mold portion, a drive mechanism for moving the second mold portion in a direction of the first mold portion, wherein the first and second mold portions bound a mold cavity, when the second mold portion is moved by the drive mechanism against the first mold portion and held in place in a clamped position by a clamping force applied by the drive mechanism, wherein the mold cavity is subdivided into at least two distinct cavity zones, with each cavity zone including sub-cavities, a single sprue having feed channels for supply of injection molding material to the cavity zones, whereby the feed channels and the cavity zones are placed into one-to-one correspondence, and a valve assembly disposed in the sprue between the feed channels and operated to control the supply of injection molding material to the cavity zones via the feed channels in time-staggered manner, when the mold portions assume their clamped position.

The present invention resolves prior art problems by combining a subdivision of the mold cavity with a time-staggered change of the flow path of the injection molding material as a function of the pressure decrease time of the internal mold pressure so that the forces that tend to move the mold portions apart can be reduced and the drive mechanism for generating the clamping force can be dimensioned to a fraction of comparable prior art constructions. Thus, the machine size for making, for example, batches of smaller injection molding articles can be significantly reduced. In addition, since the pressure decrease time is over shortly after the afterpressure phase, the overall cycle time of the process is prolonged only insignificantly as a result of the routing change of the injection molding material so that the production rate remains substantially the same.

A particular effective reduction of the machine size can be realized, when the cavity zones have substantially identical cross sectional dimension. In this way, the subdivision of the overall cavity into two cavity zones of same cross section enables a reduction of the machine size in half. Taking the example of a batch of eight drinking cups, as set forth above, this means that the eight drinking cups can be made in a single working cycle by a 150-200 to machine.

According to another aspect of the present invention, a method of making a plurality of injection-molded articles in one working cycle includes the steps of feeding injection molding material to a sprue having feed channels in communication with separate cavity zones defined between clamped mold portions, with each cavity zone including sub-cavities, wherein the feed channels and the cavity zones are placed into one-to-one correspondence, and controlling a flow of injection molding material through the feed channels, while the mold portions are clamped together, such as to charge the cavity zones with injection molding material in succession as a function of a time delay which corresponds to a time period it takes for the internal mold pressure to decrease in one cavity zone before charging the other cavity zone.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a sectional view of a closing unit according to the present invention;

FIG. 2 is a schematic plan view of a mold portion of the closing unit of FIG. 1 for making a single-piece board in accordance with the present invention;

FIG. 3 is a graph showing the relation between the internal mold pressure of the closing unit of FIG. 2 as a function of the time; and

FIG. 4 is a schematic illustration of another mold portion according to the present invention for making a batch of eight injection-molded articles.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way.

Turning now to the drawing, and in particular to FIG. 1, there is shown a sectional view of a closing unit according to the present invention, generally designated by reference numeral 1, for use in an injection molding machine for making a large-area table top, e.g. of dimensions 1200×800×4 mm of polypropylene. The closing unit 1 includes a fixed platen 3 and a moving platen 4 which is movable by a drive mechanism 2 in a movement direction of the fixed platen 3, as indicated by arrow R. The fixed platen 3 carries a mold portion 5 while the moving platen 4 carries a mold portion 6. In the illustration of FIG. 1, the mold portions 5, 6 are in clamped disposition so as to bound a mold cavity 7 in accordance with the dimensions of the table top. During the injection phase, injection molding material is injected by a plasticizing unit (not shown) via a sprue 8 in the fixed platen 3 and selectively conducted via feed channels 9, 10 into the mold cavity 7.

Conventionally, when taking into account the dimension of the table top to be injection molded and the applied inner mold pressure applied during the injection phase and ranging to 260-280 bar, the injection molding machine should be of 1600-2000 to type in order to generate the required clamping force.

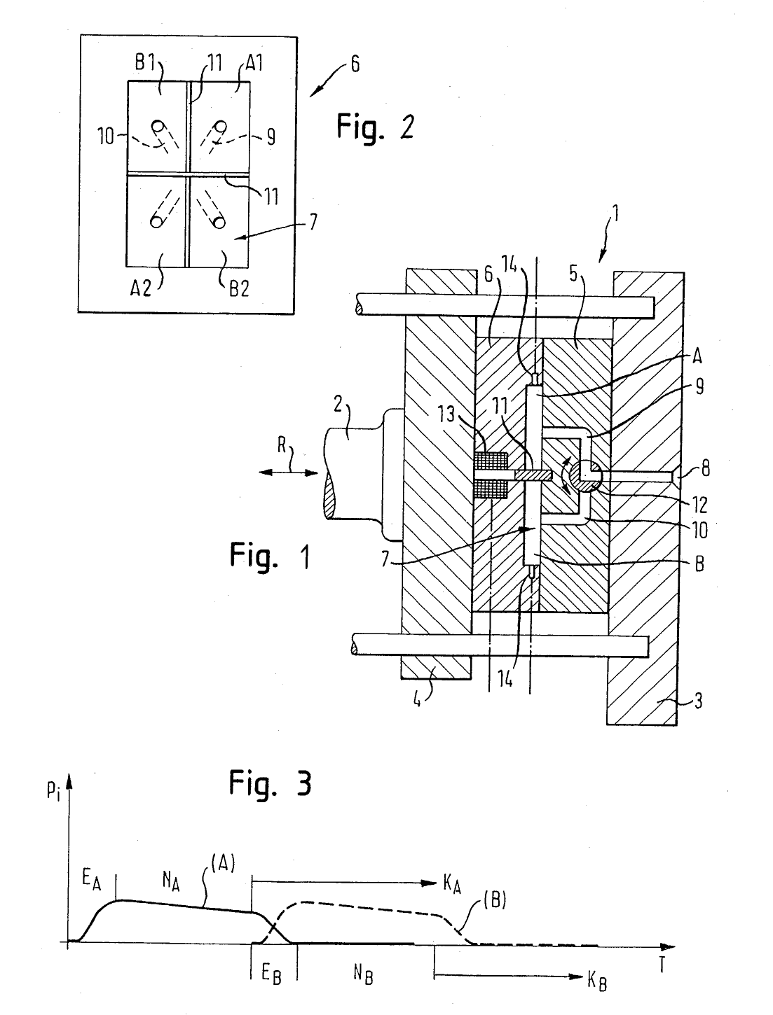

However, in accordance with the present invention, the needed clamping force and thus the machine dimension can be halved by subdividing the mold cavity 7 in four sub-cavities A1, A2; B1, B2 configured of same size and disposed in radial symmetry with respect to the movement direction R of the drive mechanism, as shown in FIG. 2. The subdivision of the mold cavity into four sub-cavities A1, A2; B1, B2 is realized by two intersecting separators 11 which are movable into position by means of electromagnetic, mechanical or pressure-controlled actuators 13. The diametrically opposed sub-cavities A1, A2 are interconnected by the feed channel 9, while the diametrically opposed sub-cavities B1, B2 are interconnected by the feed channel 10. A changeover valve 12 is placed in the sprue 8 between the feed channels 9, 10 for selectively routing the injection molding material through the feed channels 9, 10, thereby defining two distinct cavity zones A, B of same cross section.

The cavity zones A, B are charged in succession with injection molding material at a time delay in accordance with a decrease in time of the internal mold pressure in the respective one of the cavity zones A or B, whereby the actuator 13 is retracted from the mold cavity 7 between successive injection steps. The internal mold pressure can be monitored by pressure sensors 14 in the cavity zones A, B.

As only half of the cross sectional area of the mold cavity 7 is subjected to the internal mold pressure of 260-280 bar, the energy demand of the drive mechanism 2 is reduced, and the required machine size can be essentially halved. The radially symmetrical disposition of the sub-cavities A1, A2; B1, B2 or cavity zones A, B effectively precludes the presence of asymmetric forces applied by the drive mechanism 2 during the injection procedure.

FIG. 3 shows a schematic graphical illustration of the chronological pattern of the internal mold pressure pi in the injection phase E, the afterpressure phase N and the subsequent cooling phase K. In FIG. 3, the subscript “A” or “B” relates to the respective cavity zones A or B, respectively. Recognizing that the internal mold pressure pᵢ very rapidly decreases near the end of the afterpressure phase N, almost as rapidly as the increase of the internal mold pressure pᵢ to the maximum value at the beginning of the injection phase, the change in flow direction of the injection molding material for conduction to the other cavity zone, is effected immediately after elapse of the afterpressure phase N of the previously filled cavity zone. Thus, on one hand, the working cycle of the closing unit 1 is altered only insignificantly by the successive injection, i.e. prolonged approximately by the sum of the time period of E_{A} and N_{A}, and on the other hand, it is ensured that the injection plastic mass in one cavity zone has not yet solidified but is still in viscoplastic state, when coming into contact with the subsequently injected partial plastic mass of the other cavity zone. Thus, both partial plastic masses bond intimately with one another, without formation of streaks, thereby realizing a homogenous injection molded article of high surface quality, which can be ejected after a cool-down period and opening of the mold portions 5, 6.

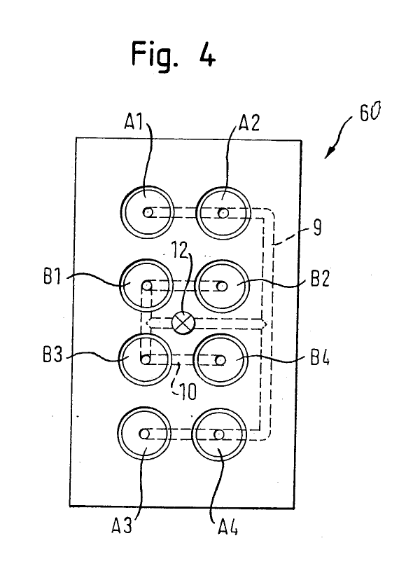

Referring now to FIG. 4, there is shown a schematic illustration of another mold portion according to the present invention, generally designated by reference numeral 60, for making a batch of eight injection-molded articles with a diameter of about 70 mm. Parts corresponding with those in FIG. 1 are denoted by identical reference numerals. The description below will center on the differences between the embodiments. Conventionally, an injection molding machine of 300-400 to type is used for the manufacture of such eight injection-molded articles. However, in accordance with the present invention, the size of the injection molding machine can now be halved by providing the cavity zone A with four sub-cavities A1, A2, A3, A4, which are fed with injection molding material via feed channel 9 and equidistant with respect to the movement axis R of the drive mechanism 2, i.e. mold center, and by providing the cavity zone B with four sub-cavities B1, B2, B3, B4, which are fed with injection molding material via feed channel 10 and also equidistant with respect to the movement axis R of the drive mechanism 2, i.e. mold center. Changeover valve 12, disposed in the sprue 8 between the feed channels 9, 10, controls the conduction of injection molding material through one or the other one of the feed channels 9, 10 for charging the respective separate cavity zones A, B in a same time-delayed manner as described in connection with the embodiment of FIG. 1. In the embodiment of FIG. 4, it is also possible to alter the injection molding material between successive injection steps. In other words, the drinking cups in the cavity zone A may be made of a different material than the drinking cups in the cavity zone B.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A closing unit for an injection molding machine for making several injection molded articles in one working cycle, comprising:
a fixed first mold portion;
a movable second mold portion;
a drive mechanism for moving the second mold portion in a direction of the first mold portion, wherein the first and second mold portions bound a mold cavity, when the second mold portion is moved by the drive mechanism against the first mold portion and held in place in a clamped position by a clamping force applied by the drive mechanism, wherein the mold cavity is subdivided into at least two distinct cavity zones, with each cavity zone including sub-cavities;
a single sprue having feed channels for supply of injection molding material to the cavity zones, whereby the feed channels and the cavity zones are placed into one-to-one correspondence; and
a valve assembly disposed in the sprue between the feed channels and operated to control the supply of injection molding material to the cavity zones via the feed channels in time-staggered manner, when the mold portions assume their clamped position.

2. The closing unit of claim 1, wherein the cavity zones have substantially identical cross sectional dimension.

3. The closing unit of claim 1, wherein the valve assembly is a changeover valve for selectively connecting the sprue with one or the other one of the cavity zones via the feed channels, said changeover valve being constructed to change the supply of injection molding material from one cavity zone to the other cavity zone after a time delay which corresponds to a time period it takes for the internal mold pressure to decrease in the one cavity zone.

4. The closing unit of claim 1, wherein the valve assembly is a changeover valve for selectively connecting the sprue with one or the other one of the cavity zones via the feed channels, said changeover valve being constructed to change the supply of injection molding material from one cavity zone to the other cavity zone immediately after conclusion of an afterpressure phase in the one cavity zone.

5. The closing unit of claim 1, and further comprising a separator assembly for subdividing the mold cavity into the at least two distinct cavity zones.

6. The closing unit of claim 5, wherein the separator assembly includes at least one pair of slides in intersecting relationship to define the cavity zones, and an actuating mechanism for moving the slides in and out of the mold cavity.

7. The closing unit of claim 3, and further comprising a pressure sensor assembly for monitoring the internal mold pressure in the cavity zones.

8. The closing unit of claim 1, wherein the first and second mold portions define a center axis, wherein the sub-cavities of each cavity zone are spaced from the center axis at a same distance.

9. The closing unit of claim 8, wherein each cavity zone has four sub-cavities.

10. A process of making a plurality of separate injection-molded articles in one working cycle, comprising the steps of:
feeding injection molding material to a sprue having feed channels in communication with at least two separate cavity zones defined between clamped mold portions, with each cavity zone including sub-cavities whereby the feed channels and the cavity zones are placed into one-to-one correspondence; and
controlling a flow of injection molding material through the feed channels, while the mold portions are clamped together, such as to charge the cavity zones with injection molding material in succession as a function of a time delay which corresponds to a time period commensurate with a decrease of internal mold pressure in one cavity zone before charging the other cavity zone.

11. The method of claim 10, wherein in a first step the injection molding material is routed through one feed channel for injection into the sub-cavities of one of the cavity zones, in a second step a changeover valve is operated to change a flow path of the injection molding material, and in a third step the injection molding material is routed through the other feed channel for injection into the sub-cavities of the other one of the cavity zones.

12. The method of claim 10, wherein the injection of injection molding material into the other cavity zone is initiated immediately after conclusion of an afterpressure phase in the one cavity zone.

13. The method of claim 11, wherein the injection molding material for injection into the sub-cavities of one of the cavity zones has a composition different from the injection molding material for injection into the sub-cavities of the other one of the cavity zones
